(19) United States
(12) Patent Application Publication
(10) Pub. No.: US 2007/0038323 A1
(43) Pub. Date: Feb. 15, 2007

(54) Method and system for collaboratively managing inventory

(76) Inventors: Gregory Howard Slocum, Dallas, TX (US); Joel Lynn Cox, North Canton, OH (US); Eric Matthew Moss, League City, TX (US)

Correspondence Address: Howard M. Cohn, Suite 220, 21625 Chagrin Blvd., Cleveland, OH, 44122, US

(21) Appl. No.: 11/200,321

(22) Filed: Aug. 9, 2005

(51) Int. Cl. G06F 19/00

(52) U.S. Cl. 700/99; 700/106; 705/28

(57) ABSTRACT

A method for automating the replenishing of inventory comprising the steps of storing current inventory level of a product at a receiving plant, storing a reserve level value of the product, storing the consumption rate of the product, storing the inventory level of shipments of the product in transit to the receiving plant, storing the inventory level of pending shipments of the product to the receiving plant, calculating a projected daily inventory level of the product at the receiving plant for a plurality of days, calculating a date when the projected daily inventory level falls below the reserve level, and calculating a date when a replenishing order for the product is to be scheduled.

### FIELD OF THE INVENTION

The present invention relates to inventory management methods and systems. More particularly, the present invention relates to vendor-managed inventory methods and systems.

### BACKGROUND

Traditional business practices have involved customers contacting vendors to place orders for materials. These orders typically state a requested quantity for delivery and a desired delivery date and, typically, a purchase order number. This contact has taken various forms from traditional mail, to telephone, to fax, to various forms of electronic data exchange. These orders have been placed based on the customer's analysis of his current inventories, consumption rates and desired inventory levels at some future time.

Because of the time involved in the transactional processes and complications around periodic price changes, orders are often placed a month at a time with requested delivery dates across the coming month. Unless the customer's consumption rates are very steady, the chances are relatively remote that a delivery ordered up to a month in advance is actually needed on the specified delivery date and not a day or two earlier or later.

Recently there have been a number of developments in Vendor Managed Inventory (VMI), wherein the customer tells his vendor what his inventories are on some regular basis, what his anticipated consumption will be, and the vendor manages the replenishment process to maintain the customer's inventory at the desired levels.

Managing that replenishment process typically involves interacting with two transactional systems: the vendor's order entry and shipping system, and the customer's purchasing, receiving and inventory systems. The inventory at the customer's location can be easily projected from the current inventory level, the customer's forecasted usage and the expected arrival of shipments the vendor has already made and orders yet to be shipped. However, when there is considerable time between the placement of orders, projecting the expected inventory at the customer location, and thus planning the replenishments is difficult.

Currently used techniques to handle this problem are not ideal. For example, one approach is to cover the forecast error with additional inventory, or safety stock, at the customer's location. This obviously involves additional costs. A second approach is to “re-work” the orders, shifting the requested delivery dates as the actual dates approach. This causes additional transactional costs and shifts the additional inventory required to cover the forecast error back onto the vendor. In either approach, inventory is committed earlier than necessary and in the second approach, the transactional overhead takes up the time of the vendor's personnel that could be more effectively used. Therefore, what is needed is an improved inventory management system that reduces the transactional overhead, and reduces the occurrences of inventory shortages and overstocks.

### SUMMARY OF THE INVENTION

The present invention is an improved method and system for vendor-managed inventory (VMI). The disclosed system and method provide improved inventory management between vendor plants and customer plants. For the purposes of this disclosure, a vendor plant is a facility that supplies a needed material to a customer plant. A customer plant is a facility that receives one or more products (e.g. raw materials, such as natural rubber) from one or more vendor plants, and outputs a product (e.g. automobile tires).

The present invention comprises two subsystems; a Daily Inventory Projection (DIP) module that projects the daily inventory levels at a customer plant, and a Replenishment Order Scheduling (ROS) module that estimates the appropriate time to place an order need to replenish the inventory of a customer plant. The aforementioned modules access information stored in one or more databases, accessible via a communications network, such as the Internet, for example. In one embodiment, all needed parameters are stored in a single database residing on the same computer as the DIP and ROS modules. However, it is possible to distribute the needed data among multiple databases residing on multiple computers within the communications network. Furthermore it is also possible that the DIP and ROS modules may be implemented in software executing on different computers, communicating via a communications network.

It is an aspect of the present invention to provide a daily inventory projection of a product at a customer plant, by considering current inventory of the product at the customer plant, the consumption rate of the product by the customer plant, the orders for the product that are already shipped from the vendor plant, and are in transit to the customer plant (referred to as Shipments In Transit (SIT)), and pending orders (orders that have been placed, but have not yet shipped from the vendor plant).

It is another aspect of the present invention to define a reserve inventory level (RIL) for a customer plant, such that a replenishing order will be scheduled to minimize the occurrences of the customer plant inventory level falling below the RIL.

It is yet another aspect of the present invention to estimate the arrival time of a replenishing order, and calculate when the replenishing order should be placed to avoid customer plant inventory level from falling below the reserve inventory level.

It is yet another aspect of the present invention to store shipping preferences, and consider these preferences when determining the date for issuing the replenishing order. These preferences may include, but are not limited to, preferred shipping method (e.g. truck/rail/boat), the approximate transit time for a shipment using the preferred shipping method, and the types of shipment accepted (e.g. only a full shipment, or a full or partial shipment).

It is yet another aspect of the present invention to define an overstock inventory level (OIL), for a customer plant, and attempt to keep the current inventory level of a given product at the customer plant below the overstock inventory level. The overstock inventory level is typically defined by the duration of time required to consume the product. For example, if a customer plant does not wish to have more than a one week supply of a given product, then the system of the present invention will attempt to make shipping decisions to prevent the customer plant inventory from exceeding a one week supply. If a full order would place the customer plant inventory level above the overstock inventory level, then the system of the present invention attempts to distribute a full order among multiple partial shipments where possible.

It is yet another aspect of the present invention to provide indirect shipments, when appropriate. In this case, a product may be shipped from one vendor plant to another vendor plant before being shipped to a customer plant. For example, a vendor plant in Baton Rouge may ship product A to a vendor plant in Houston. The vendor plant in Houston produces product B, and then combines product A and product B to be shipped to a customer plant in Chicago. In this case, the customer plant in Chicago receives both products from the vendor plant in Houston, even though product A originated from Baton Rouge.

According to the present invention, there is disclosed a method for automating the replenishing of inventory comprising the steps of: storing current inventory level of a product at a receiving plant; storing a reserve level value of said product; storing the consumption rate of said product; storing the inventory level of shipments of said product in transit to said receiving plant; storing the inventory level of pending shipments of said product to said receiving plant; calculating a projected daily inventory level of said product at said receiving plant for a plurality of days; calculating a first date when said projected daily inventory level falls below said reserve level; and calculating a second date when a replenishing order for said product is to be scheduled.

Further, according to the invention, the method includes the step of automatically ordering a shipment of said product on said second date.

Still further, according to the invention, the method includes the steps of generating a proposed order for shipment of said product on said first date; calculating a new projected daily inventory level of said product at said receiving plant for said date based on said proposed order; comparing said new projected daily inventory level to a predetermined overstock inventory level; and generating a plurality of smaller orders at different times whereby the material of the proposed order is spread out over time using multiple smaller shipments, rather than one larger shipment.

Also, according to the invention, the method includes the steps of: generating a proposed order for shipment of said product on said date; comparing quantity of said proposed order to an integral amount of shipping container capacity; and combining the pending shipments in at least one shipping container when said quantity of said proposed order is not an integral amount of shipping container capacity whereby the amount of empty cargo space in shipping containers is reduced.

Further, according to the invention, the step of combining pending shipments further comprises: identifying orders within a first shipping plant to combine with said proposed order; identifying orders within at least one additional shipping plant within a predetermined distance to said first shipping plant to combine with said proposed order; shipping orders from each said additional shipping plant to said first shipping plant to form a combined shipment; and shipping said combined shipment from said first shipping plant to said receiving plant.

According to the present invention, there is disclosed a system for automating the replenishing of inventory comprising: at least one inventory server computer, each said at least one server computer connected to a communication network; at least one inventory client computer, each of said at least one client computer connected to said communication network; said at least one server computer further comprising: means for storing current inventory level of a product at a receiving plant; means for storing a reserve level value of said product; means for storing the consumption rate of said product; means for storing the inventory level of shipments of said product in transit to said receiving plant; means for storing the inventory level of pending shipments of said product to said receiving plant; means for calculating a projected daily inventory level of said product at said receiving plant for a plurality of days; means for calculating a first date when said projected daily inventory level falls below a reserve level; and means for calculating a second date at which a replenishing order for said product is to be scheduled.

Further, according to the invention, in the system, each said client computer has means for indicating a graphical representation of a projected daily inventory level of said product at said receiving plant for a plurality of days.

Still further, according to the invention, the system further comprises means for automatically scheduling an order on said date at which a replenishing order for said product is to be scheduled.

According to the present invention, there is disclosed a system for automating the replenishing of inventory comprising: means for storing current inventory level of a product at a receiving plant; means for storing a reserve level value of said product; means for storing the consumption rate of said product; means for storing the inventory level of shipments of said product in transit to said receiving plant; means for storing the inventory level of pending shipments of said product to said receiving plant; means for calculating a projected daily inventory level of said product at said receiving plant for a plurality of days; means for calculating a first date when said projected daily inventory level falls below said reserve level; and means for calculating a second date when a replenishing order for said product is to be scheduled.

Further, according to the invention, the system further comprises means for automatically ordering a shipment of said product on said date.

Still further, according to the invention, the system further comprises : means for generating a proposed order for shipment of said product on said date; means for calculating a new projected daily inventory level of said product at said receiving plant for said date based on proposed order; means for comparing said new projected daily inventory level to a predetermined overstock inventory level; and means for generating a plurality of smaller orders at different times; whereby the material of the proposed order is spread out over time using multiple smaller shipments, rather than one larger shipment. Yet further, according to the invention, the system comprises: means for generating a proposed order for shipment of said product on said date; means for comparing quantity of said proposed order to an integral amount of shipping container capacity; and means for combining pending orders in at least one shipping container when said quantity of said proposed order is not an integral amount of shipping container capacity; whereby the amount of empty cargo space in shipping containers is reduced.

Further, according to the invention, the means for combining pending orders further comprises: means for identifying orders within a first shipping plant to combine with said proposed order; means for identifying orders within at least one additional shipping plant within a predetermined distance to said first shipping plant to combine with said proposed order; means for shipping orders from each said additional shipping plant to said first shipping plant to form a combined shipment; and means for shipping said combined shipment from said first shipping plant to said receiving plant.

Other aspects and advantages provided by the present invention will be apparent from the detailed description that follows.

### BRIEF DESCRIPTION OF DRAWINGS

The structure, operation, and advantages of the present invention will become apparent upon consideration of the description herein below taken in conjunction with the accompanying FIGURES (FIGs). The FIGURES are intended to be illustrative, not limiting. Certain elements in some of the FIGURES may be omitted, or illustrated not-to-scale, for illustrative clarity. The cross-sectional views may be in the form of “slices,” or “near-sighted” cross-sectional views, omitting certain background lines which would otherwise be visible in a “true” cross-sectional view, for illustrative clarity.

Although the invention is generally described in the context of these preferred embodiments, it should be understood that the FIGURES are not intended to limit the spirit and scope of the invention to these particular embodiments.

Certain elements in selected ones of the FIGURES may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the FIGURES can be numbered such that similar (including identical) elements may be referred to with similar numbers in a single FIGURE. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications, e.g., a tire 109 having a static imbalance versus a different tire 109′ of the same design, but having a couple imbalance. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying FIGURES, wherein:

FIG. 1 shows a block diagram of an exemplary embodiment of a vendor-managed inventory system, in accordance with the present invention;

FIG. 2 shows a block diagram indicating attributes of a vendor plant and a customer plant, in accordance with the present invention;

FIG. 3 shows an exemplary Shipment Preferences Table, in accordance with the present invention;

FIG. 4 shows a diagrammatic representation of a Transportation Table, in accordance with the present invention;

FIG. 5 is a flowchart showing the derivation of date D_{R}, in accordance with the present invention;

FIG. 6 is a flowchart showing an algorithm for selecting a shipping method and scheduling an order date, in accordance with the present invention;

FIG. 7 is a flowchart showing an alternate algorithm for selecting a shipping method and scheduling an order date, in accordance with the present invention; and

FIG. 8 is a flowchart showing an additional alternate algorithm for selecting a shipping method and scheduling an order date, in accordance with the present invention.

### DETAILED DESCRIPTION OF PREFERRED EMBODIMENTS

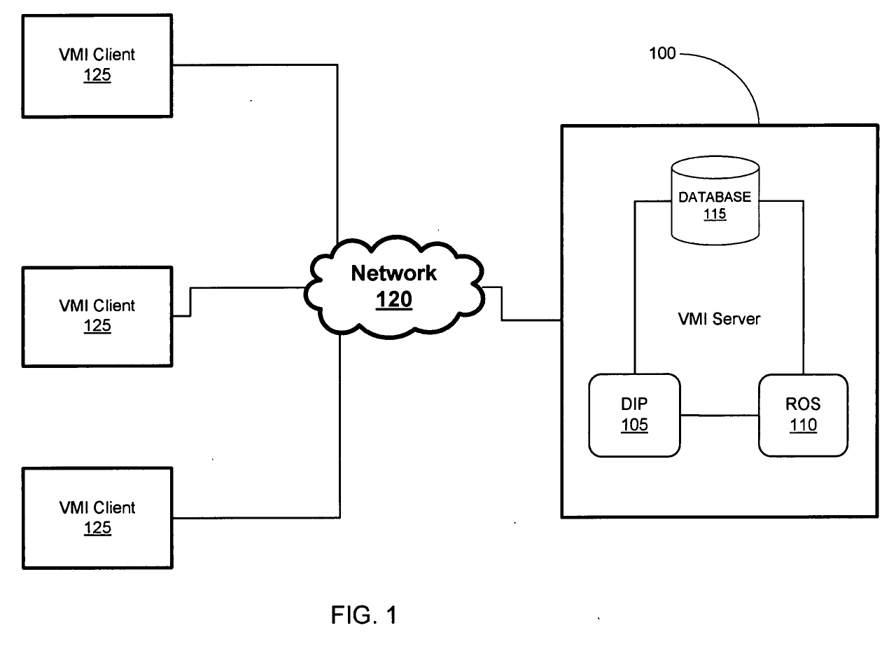

FIG. 1 shows a block diagram of an exemplary embodiment of a vendor-managed inventory (VMI) system of the present invention. VMI server computer 100 is connected to a plurality of VMI client computers, indicated generally as 125, via a communications network 120. In most cases, the VMI client computers 125 will be distributed amongst the various vendor plants and customer plants participating in the vendor-managed inventory network of vendor plants and customer plants. VMI server 100 has a Daily Inventory Projection (DIP) module 105 that projects an Estimated Daily Inventory (EDI) level at a customer plant, and a Replenishment Order Scheduling (ROS) module 110 that estimates the appropriate time to place an order need to replenish the inventory of a customer plant. DIP module 105 and ROS module 110 execute algorithms that use data stored in database 115 as input. VMI client computers 125 provide a user interface to users at the various plants within the vendor-managed network of vendor plants and customer plants. The user interface provides information which may include, but is not limited to, a graphical representation of the Estimated Daily Inventory (EDI) level for specific duration of time, data pertaining Shipments In Transit and pending orders, and current inventory levels at each plant.

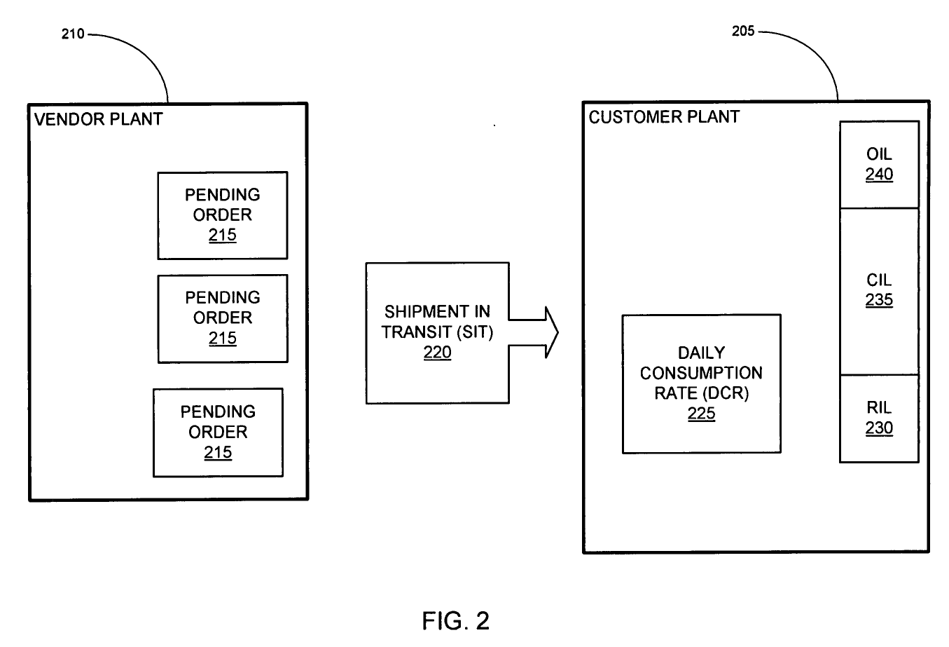

FIG. 2 shows a block diagram indicating attributes of a vendor plant 210 and a customer plant 205. Vendor plant 210 may have one or more pending orders 215. These are orders that have been placed, but have not yet shipped from vendor plant 210. Shipment In Transit (SIT) 220 represents an order that has left the premises of vendor plant 210, but has not yet arrived at customer plant 205. Customer plant 205 has multiple attributes associated with it. Current Inventory Level (CIL) 235 represents the current inventory level of a given product at customer plant 205. Overstock Inventory Level (OIL) represents a maximum desired inventory level for a given product at customer plant 205. If the inventory rises above the OIL, it is considered excessive, and therefore not cost effective for customer plant operations. Reserve Inventory Level (RIL) 230 represents a minimum safe inventory level for a given product at customer plant 205. If inventory falls below the RIL, then the customer plant may be at risk for disruption of production. The vendor-managed inventory system of the present invention attempts to maintain a customer plant inventory level between the RIL and the OIL, and preferably as close to the RIL as possible without falling below it.

Daily Consumption Rate (DCR) 225 represents the daily usage rate of customer plant 205 for a given product. While the example provided uses a daily consumption rate, it is possible to use a different time interval to measure consumption, such as a weekly consumption rate or monthly consumption rate.

Daily Inventory Projection (DIP) module 105 projects the EDI level at the customer plant 205 for a number of days into the future (e.g. 30 days). The DIP module 105 uses the CIL, DCR, SIT orders and pending orders to perform this analysis. Orders, whether pending or SIT have various attributes associates with them, including, but not limited to, product identifier, product quantity and estimated arrival date. The DIP module can then provide an EDI for a number of days into the future for a given product at the customer plant. The EDI falls below the RIL at a particular date D_{R}. This date is provided to the Replenishment Order Scheduling (ROS) module 110 to use in determining when a replenishment order should be placed.

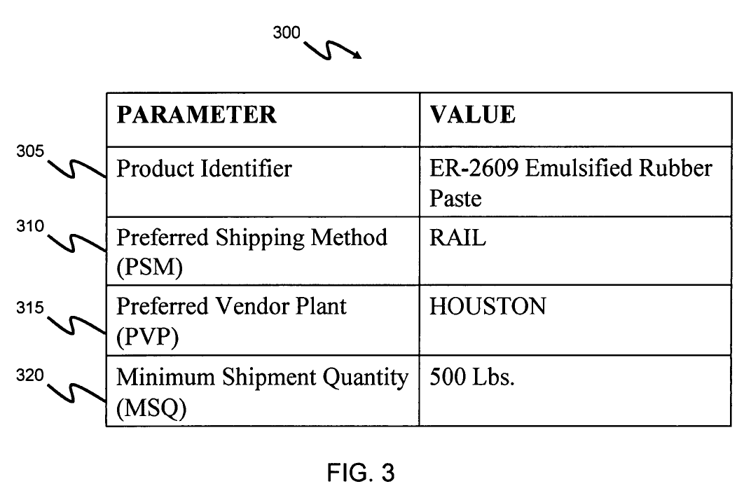

FIG. 3 shows an exemplary Shipment Preferences Table (SPT) 300. The information contained in SPT 300 is used by the Replenishment Order Scheduling (ROS) module 110 to choose an appropriate shipment method and scheduled order date. The information may include, but is not limited to, Product Identifier 305, which identifies the product via an alphanumeric identifier and/or product name, Preferred Shipping Method (PSM) 310, which identifies the preferred shipping method as RAIL, a Preferred Vendor Plant (PVP) 315, which indicates the HOUSTON vendor plant as the preferred vendor plant for this example, and a minimum shipment quantity (MSQ) which indicates the minimum amount of product that the customer plant 205 is willing to receive in a shipment, in this case, 500 pounds.

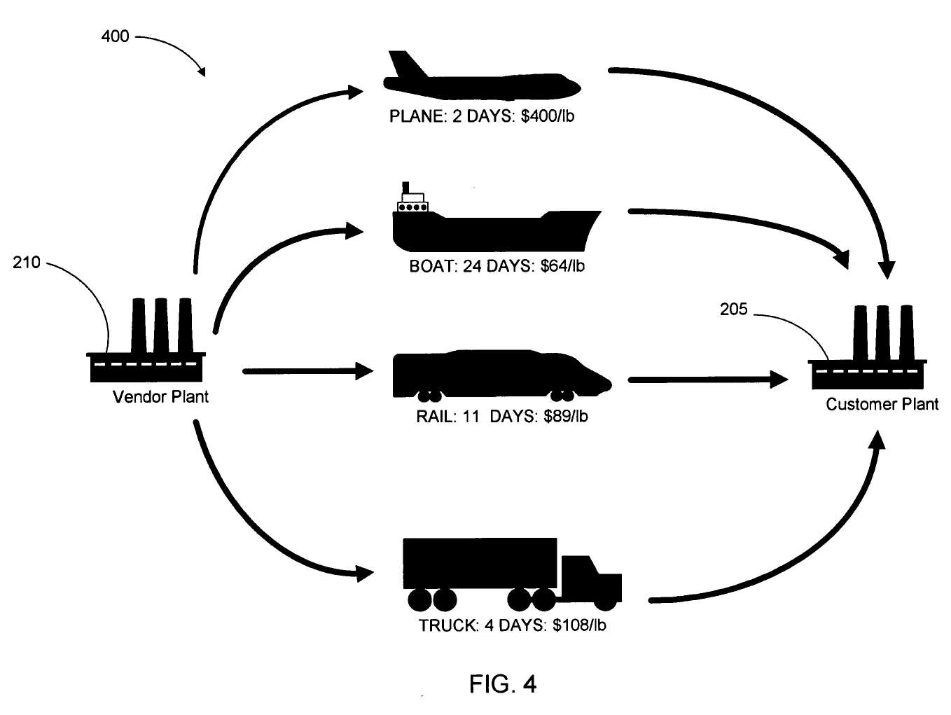

FIG. 4 shows a diagrammatic representation of a Transportation Table (TT) 400. The information contained in TT 400 is used by the Replenishment Order Scheduling (ROS) module 110 to choose an appropriate shipment method and scheduled order date. The information may include, but is not limited to, method of transport, such as plane, boat, rail or truck, average transit time between vendor plant 210 and customer plant 205, and a cost parameter. In the example shown in FIG. 4, the cost parameter is measured in dollars per pound. However, it is possible to have another cost parameter within the scope of the present invention.

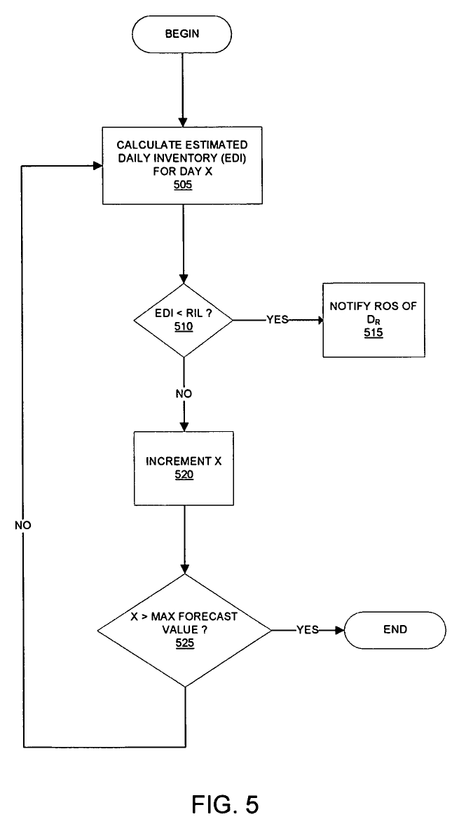

FIG. 5 is a flowchart showing the derivation of date D_{R}. This is the date when the EDI falls below the RIL. In other words, it is the date at which the inventory of a given product at the customer plant is estimated to be below the minimum safety level, thereby putting customer plant operation at risk. In step 505, the Estimated Daily Inventory (EDI) is calculated for a given day, based on current inventory level (CIL), Daily Consumption Rate (DCR), and incoming shipments, both Shipments In Transit (SIT) and pending orders. In step 510 the EDI is compared with the RIL. If the EDI is less than the RIL, then the date D_{R} is now known, and this value is provided to the ROS module in step 515. If the EDI is not less than the RIL, the algorithm tries the next day (or appropriate time unit) by incrementing the day in step 520. The new value for X is compared against the max forecast value in step 525. For example, if the maximum desired forecast is 30 days, then as long as X is less than or equal to 30, a new EDI is generated.

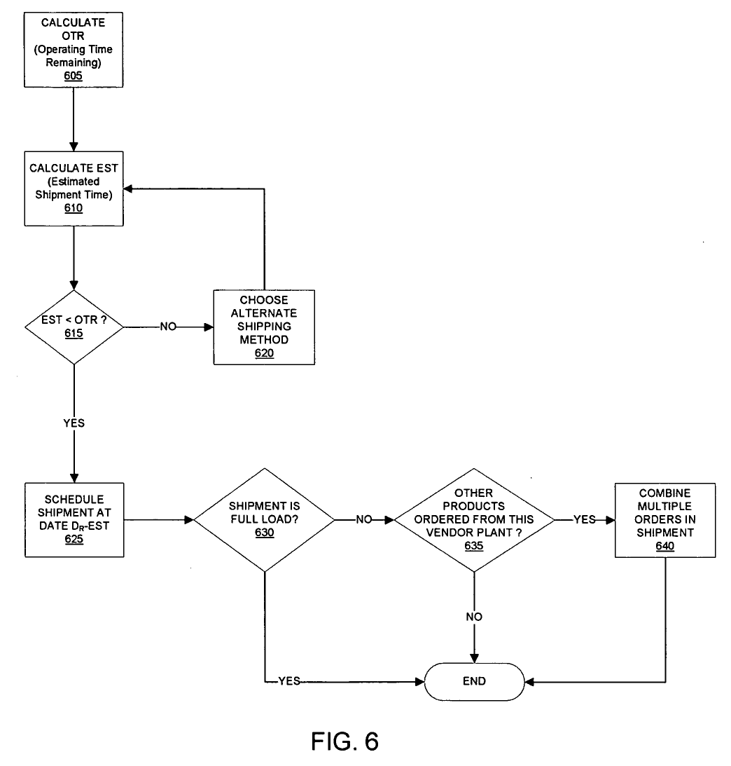

FIG. 6 is a flowchart showing an algorithm for selecting a shipping method and scheduling an order date. In step 605, the Operating Time Remaining (OTR) is calculated. This is the time between today and D_{R}. In step 610 the Estimated Shipping Time (EST) is calculated. This is derived from the data in the Shipment Preferences Table (SPT) 300 and Transportation Table (TT) 400. In step 615 the EST is compared with the OTR. If the EST is less than the OTR, then the shipment date is scheduled at date D_{R}−EST. For example, assume today is July 6, and D_{R} is July 29. This means that if no action is taken, the inventory of a given product at the customer plant will fall below the RIL on July 29. If the preferred shipment method is rail, and a shipment by rail takes 11 days, then D_{R}−EST gives the scheduled order date of July 18 at step 625. At step 630, the shipment size is evaluated to determine if it is an integral amount as compared with shipping container capacity. For the purposes of this disclosure, an “integral amount” means an amount sufficient to fill an integer number of shipping containers. In other words, if a shipment is of an integral amount, it may require 3 truckloads. However, if it requires 3.5 truckloads, then there is a half-truckload of empty space in one of the trucks. If this half-truckload of empty cargo space can be filled with another product that needs to be shipped, then overall shipping efficiency will be increased.

In an exemplary embodiment, if the shipment size is less than one truck load, other orders from this vendor plant to the destination customer plant are checked to see if any of those can be combined to make a full truck load in step 635. If so, the orders are combined in step 640. This increases the efficiency of the trucks used to transport the products.

Suppose the preferred shipping method is boat, and a shipment by boat takes 24 days, then the EST is greater than the OTR. In other words, 24 days before D_{R} is July 5. Since, for the purposes of this example, today is July 6, it is too late to order a shipment by boat. Therefore, an alternate shipping method such as rail is chosen in step 620, and the comparison in step 615 is made again.

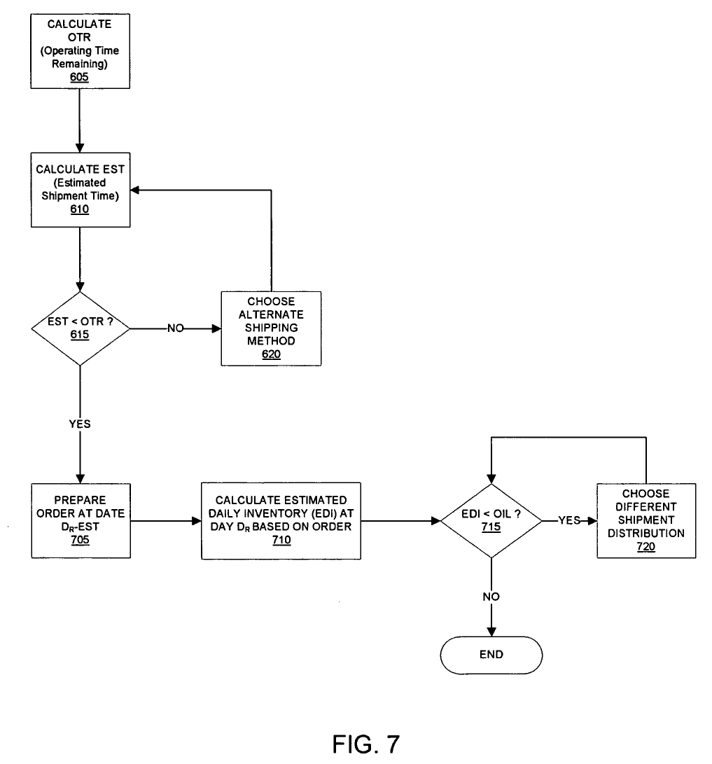

FIG. 7 is a flowchart showing an alternate algorithm for selecting a shipping method and scheduling an order date. It is similar to that of FIG. 6, but has some additional steps for improving efficiency. In this case, the order date is calculated in step 705 using D_{R}−EST, similar to step 625 of FIG. 6. However, instead of scheduling the order at that point, the order is considered to be a proposed order, and additional checks are made before the proposed order is actually placed. In step 710, the EDI is projected at date D_{R} considering the proposed order. If the EDI at DR exceeds the Overstock Inventory Limit (OIL), then a different shipment distribution is selected in step 720. For example, if a customer plant were to receive a full truckload of a month's supply of a given product at date DR, and receipt of that shipment would put the current inventory level above the OIL, then the shipment may be distributed as two half-truckloads shipped at two-week intervals. This technique prevents inventory at the customer plant from getting too high. Inventories that are too high are undesirable for efficient plant operation due to excess cost, as well as the overhead of stocking additional inventory.

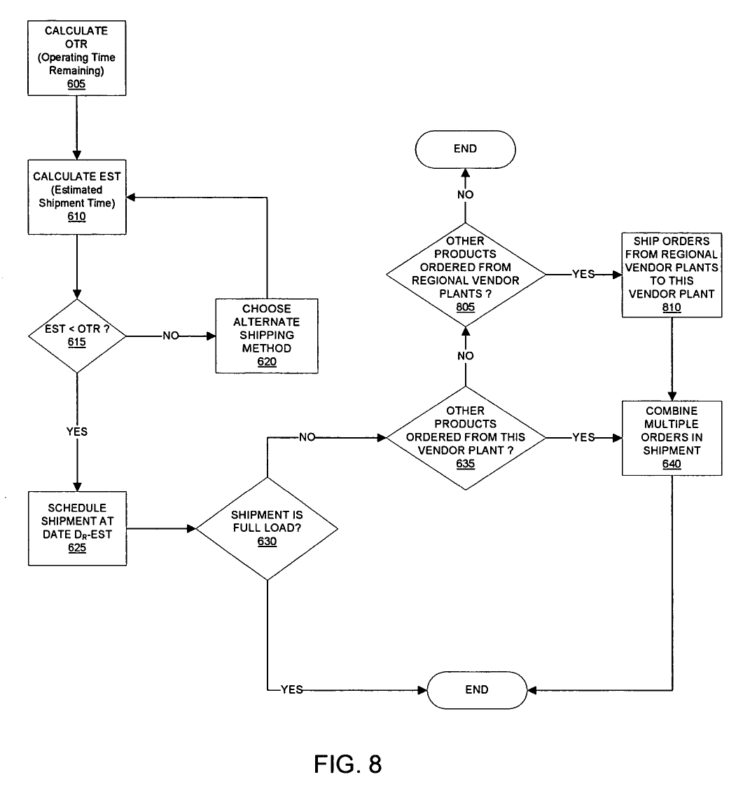

FIG. 8 is a flowchart showing an additional alternate algorithm for selecting a shipping method and scheduling an order date. It is similar to that of FIG. 6, but has some additional steps for improving efficiency. In this case, if there are no additional orders from the current vendor plant found in step 635, then orders from regional vendor plants are checked in step 805. A regional vendor plant is defined as a plant within a predetermined distance from a given vendor plant.

For example, suppose a vendor plant in Houston needs to ship product A to a customer plant in Chicago. However, the quantity of product A does not completely fill a truckload. The Houston vendor plant will first attempt to combine another order from the Houston plant to make a complete truckload. However, if there are no other orders from the Houston plant to complete the truckload, then a shipment of product B from a regional plant in Corpus Christi is sent to the Houston plant. Product A and product B are then combined in a truckload, and shipped from Houston to Chicago.

It will be understood that the present invention may have various other embodiments, such as combinations of the algorithms described herein. For example, the algorithm of FIG. 7 and that of FIG. 8 may be combined to implement at system that both utilizes regional vendor plants, and attempts to avoid an overstock condition.

Although the present invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for automating the replenishing of inventory comprising the steps of:
storing current inventory level of a product at a receiving plant;
storing a reserve level value of said product;
storing the consumption rate of said product;
storing the inventory level of shipments of said product in transit to said receiving plant;
storing the inventory level of pending shipments of said product to said receiving plant;
calculating a projected daily inventory level of said product at said receiving plant for a plurality of days;
calculating a first date when said projected daily inventory level falls below said reserve level; and
calculating a second date when a replenishing order for said product is to be scheduled.

2. The method of claim 1, further comprising the step of automatically ordering a shipment of said product on said second date.

3. The method of claim 1, further comprising the steps of:
generating a proposed order for shipment of said product on said first date;
calculating a new projected daily inventory level of said product at said receiving plant for said date based on said proposed order;
comparing said new projected daily inventory level to a predetermined overstock inventory level; and
generating a plurality of smaller orders at different times whereby the material of the proposed order is spread out over time using multiple smaller shipments, rather than one larger shipment.

4. The method of claim 1, further comprising the steps of:
generating a proposed order for shipment of said product on said first date;
comparing quantity of said proposed order to an integral amount of shipping container capacity; and
combining the pending shipments in at least one shipping container when said quantity of said proposed order is not an integral amount of shipping container capacity whereby the amount of empty cargo space in shipping containers is reduced.

5. The method of claim 4, wherein the step of combining pending shipments further comprises:
identifying orders within a first shipping plant to combine with said proposed order;
identifying orders within at least one additional shipping plant within a predetermined distance to said first shipping plant to combine with said proposed order;
shipping orders from each said additional shipping plant to said first shipping plant to form a combined shipment; and
shipping said combined shipment from said first shipping plant to said receiving plant.

6. A system for automating the replenishing of inventory comprising:
at least one inventory server computer, each said at least one server computer connected to a communication network;
at least one inventory client computer, each of said at least one client computer connected to said communication network;
said at least one server computer further comprising:
means for storing current inventory level of a product at a receiving plant;
means for storing a reserve level value of said product;
means for storing the consumption rate of said product;
means for storing the inventory level of shipments of said product in transit to said receiving plant;
means for storing the inventory level of pending shipments of said product to said receiving plant;
means for calculating a projected daily inventory level of said product at said receiving plant for a plurality of days;
means for calculating a first date when said projected daily inventory level falls below a reserve level; and
means for calculating a second date at which a replenishing order for said product is to be scheduled.

7. The system of claim 6, wherein each said client computer has means for indicating a graphical representation of a projected daily inventory level of said product at said receiving plant for a plurality of days.

8. The system of claim 6, further comprising means for automatically scheduling an order on said second date at which a replenishing order for said product is to be scheduled.

9. A system for automating the replenishing of inventory comprising:
means for storing current inventory level of a product at a receiving plant;
means for storing a reserve level value of said product;
means for storing the consumption rate of said product;
means for storing the inventory level of shipments of said product in transit to said receiving plant;
means for storing the inventory level of pending shipments of said product to said receiving plant;
means for calculating a projected daily inventory level of said product at said receiving plant for a plurality of days;
means for calculating a first date when said projected daily inventory level falls below said reserve level; and
means for calculating a second date when a replenishing order for said product is to be scheduled.

10. The system of claim 9, further comprising means for automatically ordering a shipment of said product on said second date.

11. The system of claim 9, further comprising:
means for generating a proposed order for shipment of said product on said first date;
means for calculating a new projected daily inventory level of said product at said receiving plant for said date based on proposed order;
means for comparing said new projected daily inventory level to a predetermined overstock inventory level; and
means for generating a plurality of smaller orders at different times;
whereby the material of the proposed order is spread out over time using multiple smaller shipments, rather than one larger shipment.

12. The system of claim 9, further comprising:
means for generating a proposed order for shipment of said product on said date;
means for comparing quantity of said proposed order to an integral amount of shipping container capacity; and
means for combining pending orders in at least one shipping container when said quantity of said proposed order is not an integral amount of shipping container capacity;
whereby the amount of empty cargo space in shipping containers is reduced.

13. The system of claim 9, wherein the means for combining pending orders further comprises:
means for identifying orders within a first shipping plant to combine with said proposed order;
means for identifying orders within at least one additional shipping plant within a predetermined distance to said first shipping plant to combine with said proposed order;
means for shipping orders from each said additional shipping plant to said first shipping plant to form a combined shipment; and
means for shipping said combined shipment from said first shipping plant to said receiving plant.
